(19) United States
(12) Patent Application Publication
(10) Pub. No.: US 2018/0174265 A1
(43) Pub. Date: Jun. 21, 2018

(54) SYSTEMS AND METHODS FOR DETERMINING A TARGET VEHICLE/PROVIDER

(71) Applicant: BEIJING DIDI INFINITY TECHNOLOGY AND DEVELOPMENT CO., LTD., Beijing (CN)

(72) Inventors: Sicheng LIU, Beijing (CN); Wei ZENG, Beijing (CN); Hantao RONG, Beijing (CN)

(73) Assignee: BEIJING DIDI INFINITY TECHNOLOGY AND DEVELOPMENT CO., LTD., Beijing (CN)

(21) Appl. No.: 15/884,335

(22) Filed: Jan. 30, 2018

Related U.S. Application Data
(63) Continuation of application No. PCT/CN2016/107352, filed on Nov. 25, 2016.

(30) Foreign Application Priority Data
Dec. 24, 2015 (CN) 201510993506.1

(51) Int. Cl. G06Q 50/30; G06Q 10/04

(52) U.S. Cl. CPC G06Q 50/30; G06Q 10/04

(57) ABSTRACT

The present disclosure relates to systems and methods for determining a target vehicle and a target provider for a service request. The systems may perform the methods to obtain a service request from a requestor for an authority to drive a vehicle by the requestor; determine a target vehicle corresponding to a target provider based on the service request; and direct the target provider to send the target vehicle to the requestor.

### CROSS-REFERENCE TO RELATED APPLICATIONS

This application is a continuation of International Application No. PCT/CN2016/107352, filed on Nov. 25, 2016, which designates the United States of America and claims priority to Chinese Application No. 201510993506.1 filed on Dec. 24, 2015, the content of which is incorporated herein by reference.

### TECHNICAL FIELD

The present disclosure generally relates to systems and methods for on-demand service, and in particular, systems and methods for determining a target vehicle/provider for a service request.

### BACKGROUND

On-demand service has become more and more popular. In the on-demand service, especially in a test drive service, the requestors' requests relating to a vehicle/provider may be various. Under certain circumstances, it may be difficult to meet the various requests or to determine a target vehicle/provider efficiently.

### SUMMARY

According to an aspect of the present disclosure, a system may include one or more storage media and one or more processors configured to communicate with the one or more storage media. The one or more storage media may include a set of instructions for determining a target provider for a service request. When the one or more processors executing the set of instructions, the one or more processors may be directed to perform one or more of the following operations. The one or more processors may obtain a service request from a requestor for an authority to drive a vehicle by the requestor. The one or more processors may determine a target vehicle corresponding to a target provider based on the service request. The one or more processors may direct the target provider to send the target vehicle to the requestor.

In some embodiments, the service request may be a test drive request to test drive the target vehicle.

In some embodiments, the one or more processors may obtain the service request from a requestor terminal associated with the requestor. In some embodiments, the one or more processors may direct the target provider to send the target vehicle to the start location via a provider terminal associated with the target provider.

In some embodiments, the requestor terminal may include at least one of a mobile terminal, a computer, and/or a wearable device. In some embodiments, the provider terminal may include at least one of a mobile terminal, a computer, and/or a wearable device.

In some embodiments, the service request may include at least one of a start location to drive the target vehicle and/or an individualized definition of the vehicle. In some embodiments, the service request may further include an open destination.

In some embodiments, the start location may be a current location of the requestor or a defined location by the requestor.

In some embodiments, the one or more processors may further obtain the start location and notify the start location to the target provider.

In some embodiments, the individualized definition of the vehicle may include at least one preference parameter, which includes at least one of a vehicle brand, a vehicle model, an overall dimension, an inner dimension, a driving type, a displacement, a gear box, a clutch, a fuel tank, a brake system, a steering system, a self-driving system, an air conditioning, an audio system, a lamp, a seat, a maximum speed, a horse power, a vehicle age, a color, a painting, a decoration, a muffler, and/or new energy.

In some embodiments, the one or more processors may send the service request to a plurality of candidate providers within a predetermined distance from the start location, wherein each of the plurality of candidate providers may be associated with a candidate vehicle. The one or more processors may receive an acceptance of the service request from at least one candidate provider of the plurality of candidate providers. The one or more processors may then select one candidate provider from the at least one of candidate providers as the target provider.

In some embodiments, the one or more processors may obtain status information of each of a plurality of vehicles, wherein each of the plurality of vehicles may be associated with a provider of the plurality of providers. The one or more processors may determine a plurality of available vehicles based on the status information, wherein each of the plurality of available vehicles may be a vehicle that is available to provide the requestor the authority to drive the available vehicle. The one or more processors may select the plurality of candidate vehicles that matches the service request from the plurality of available vehicles. The one or more processors may then send the service request to the plurality of candidate providers associated with the plurality of candidate vehicles within the predetermined distance from the start location.

In some embodiments, the one or more processors may determine whether the service request is cancelled and update the status information.

In some embodiments, the one or more processors may determine vehicle information of the available vehicles and match the individualized definition of the vehicle with the vehicle information.

In some embodiments, the plurality of candidate providers may include at least one of a dealer, a private seller, and/or a private owner of the candidate vehicle.

In some embodiments, the one or more processors may further collect data relating to the requestor, wherein the data may include historical service requests by the requestor. The one or more processors may determine a recommendation based on the data. The one or more processors may then notify the recommendation to the requestor.

In some embodiments, the one or more processors may collect personal information from the requestor and determine eligibility information of the requestor.

In some embodiments, the one or more processors may collect personal information from the candidate provider and determine eligibility information of the candidate provider.

In some embodiments, the one or more processors may estimate a service fee based on the service request and send the estimated service fee to the requestor.

According to another aspect of the present disclosure, a method may include one or more of the following operations. A computer server may obtain a service request from a requestor for an authority to drive a vehicle by the requestor. The computer server may determine a target vehicle corresponding to a target provider based on the service request. The computer server may direct the target provider to send the target vehicle to the requestor.

In some embodiments, the service request may be a test drive request to test drive the target vehicle.

In some embodiments, the computer server may obtain the service request from a requestor terminal associated with the requestor. In some embodiments, the computer server may direct the target provider to send the target vehicle to the start location via a provider terminal associated with the target provider.

In some embodiments, the requestor terminal may include at least one of a mobile terminal, a computer, and/or a wearable device. In some embodiments, the provider terminal may include at least one of a mobile terminal, a computer, and/or a wearable device.

In some embodiments, the service request may include at least one of a start location to drive the target vehicle and/or an individualized definition of the vehicle. In some embodiments, the service request may further include an open destination.

In some embodiments, the start location may be a current location of the requestor or a defined location by the requestor.

In some embodiments, the computer server may further obtain the start location and notify the start location to the target provider.

In some embodiments, the individualized definition of the vehicle may include at least one preference parameter, which includes at least one of a vehicle brand, a vehicle model, an overall dimension, an inner dimension, a driving type, a displacement, a gear box, a clutch, a fuel tank, a brake system, a steering system, a self-driving system, an air conditioning, an audio system, a lamp, a seat, a maximum speed, a horse power, a vehicle age, a color, a painting, a decoration, a muffler, and/or new energy.

In some embodiments, the computer server may send the service request to a plurality of candidate providers within a predetermined distance from the start location, wherein each of the plurality of candidate providers may be associated with a candidate vehicle. The computer server may receive an acceptance of the service request from at least one candidate provider of the plurality of candidate providers. The computer server may then select one candidate provider from the at least one of candidate providers as the target provider.

In some embodiments, the computer server may obtain status information of each of a plurality of vehicles, wherein each of the plurality of vehicles may be associated with a provider of the plurality of providers. The computer server may determine a plurality of available vehicles based on the status information, wherein each of the plurality of available vehicles may be a vehicle that is available to provide the requestor the authority to drive the available vehicle. The computer server may select the plurality of candidate vehicles that matches the service request from the plurality of available vehicles. The computer server may then send the service request to the plurality of candidate providers associated with the plurality of candidate vehicles within the predetermined distance from the start location.

In some embodiments, the computer server may determine whether the service request is cancelled and update the status information.

In some embodiments, the computer server may determine vehicle information of the available vehicles and match the individualized definition of the vehicle with the vehicle information.

In some embodiments, the plurality of candidate providers may include at least one of a dealer, a private seller, and/or a private owner of the candidate vehicle.

In some embodiments, the computer server may further collect data relating to the requestor, wherein the data may include historical service requests by the requestor. The computer server may determine a recommendation based on the data. The computer server may then notify the recommendation to the requestor.

In some embodiments, the computer server may collect personal information from the requestor and determine eligibility information of the requestor.

In some embodiments, the computer server may collect personal information from the candidate provider and determine eligibility information of the candidate provider.

In some embodiments, the computer server may estimate a service fee based on the service request and send the estimated service fee to the requestor.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a block diagram illustrating an exemplary on-demand service system according to some embodiments of the present disclosure;

FIG. 2 is a block diagram illustrating an exemplary computing device in the on-demand service system according to some embodiments of the present disclosure;

FIG. 3-A is a block diagram illustrating an exemplary processing engine according to some embodiments of the present disclosure;

FIG. 3-B is a flowchart illustrating an exemplary process/method for determining a target vehicle/provider according to some embodiments of the present disclosure;

FIGS. 4-A and 4-B illustrate an exemplary process/method for determining a target vehicle/provider according to some embodiments of the present disclosure;

FIG. 5 is a flowchart illustrating an exemplary process/method for sending a service request to one or more candidate vehicles according to some embodiments of the present disclosure;

FIG. 6 is a schematic diagram illustrating an exemplary user interface for user registration according to some embodiments of the present disclosure;

FIGS. 7-A and 7-B are schematic diagrams illustrating exemplary user interfaces for user registration according to some embodiments of the present disclosure;

FIGS. 8-A and 8-B are schematic diagrams illustrating exemplary user interfaces for requestor according to some embodiments of the present disclosure;

FIG. 9 is a schematic diagram illustrating an exemplary user interface for requestor according to some embodiments of the present disclosure;

FIG. 10 is a block diagram illustrating an exemplary database according to some embodiments of the present disclosure;

FIG. 11 is a schematic diagram illustrating an exemplary statistical graph according to some embodiments of the present disclosure; and

FIG. 12 is a flowchart illustrating an exemplary process/method for sending one or more recommendations to a requestor according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawing(s), all of which form a part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily in regard to determining a target vehicle/provider, it should also be understood that this is only one exemplary embodiment. The system or method of the present disclosure may be applied to any other kind of on-demand service. For example, the system or method of the present disclosure may be applied to different transportation systems including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system that applies management and/or distribution, for example, a system for sending and/or receiving an express. The application scenarios of the system or method of the present disclosure may include a webpage, a plug-in of a browser, a client terminal, a custom system, an internal analysis system, an artificial intelligence robot, or the like, or any combination thereof.

The term “passenger,” “requester,” “service requester,” and “customer” in the present disclosure are used interchangeably to refer to an individual, an entity or a tool that may request or order a service. Also, the term “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity or a tool that may request a service, order a service, provide a service, or facilitate the providing of the service. For example, the user may be a passenger, a driver, an operator, or the like, or any combination thereof. In the present disclosure, “passenger” and “passenger terminal” may be used interchangeably, and “driver” and “driver terminal” may be used interchangeably.

The term “service request” and “order” in the present disclosure are used interchangeably to refer to request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable, or free.

The positioning technology used in the present disclosure may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning technologies may be used interchangeably in the present disclosure.

An aspect of the present disclosure provides online systems and methods for a user to order a test drive service of an individually defined vehicle, where the service provider (e.g., vehicle owner) sends a matching vehicle to wherever the user requests to start the test drive.

It should be noted that online on-demand transportation services, such as online taxi and/or test drive calling, is a new form of service rooted only in post-Internet era. It provides technical solutions to users and service providers that could raise only in post-Internet era. In pre-Internet era, when a user calls for a taxi on street, the taxi request and acceptance occur only between the passenger and one taxi driver that sees the passenger. If the passenger calls a taxi through telephone call, the service request and acceptance may occur only between the passenger and one service provider (e.g., one taxi company or agent). Online taxi and/or test drive calling, however, allows a user of the service to real-time and automatic distribute a service request to a vast number of individual service providers (e.g., taxi) distance away from the user. It also allows a plurality of service provides to respond to the service request simultaneously and in real-time. Therefore, through Internet, the online on-demand transportation systems may provide a much more efficient transaction platform for the users and the service providers that may never met in a traditional pre-Internet transportation service system.

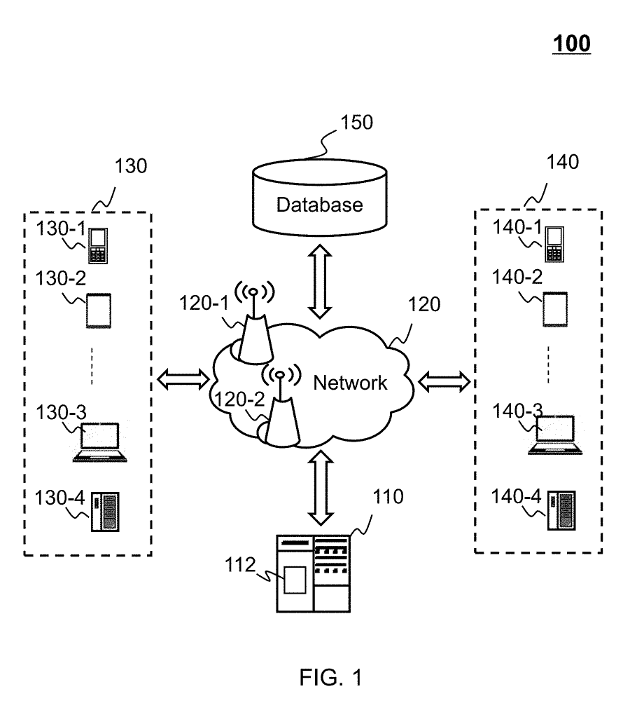

FIG. 1 is a block diagram of an exemplary on-demand service system 100 according to some embodiments. The on-demand service system 100 may be an online platform including a server 110, a network 120, a requestor terminal 130, a provider terminal 140, and a database 150. The server 110 may include a processing engine 112.

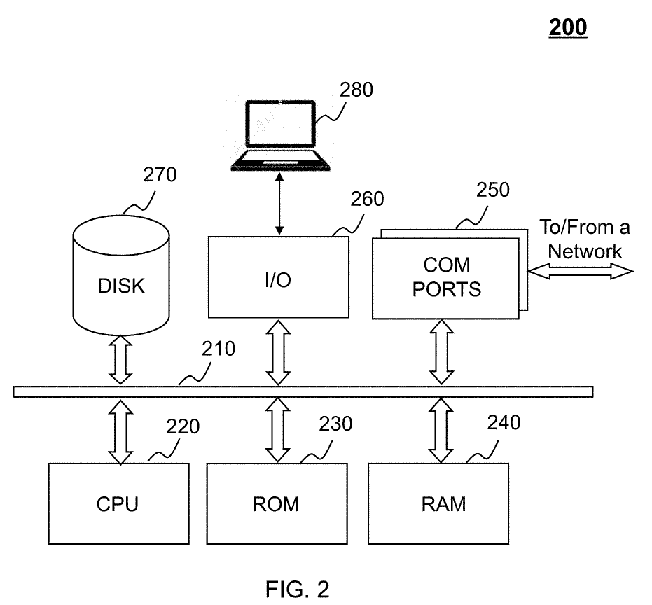

In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the requestor terminal 130, the provider terminal 140, and/or the database 150 via the network 120. As another example, the server 110 may be directly connected to the requestor terminal 130, the provider terminal 140, and/or the database 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data relating to the service request to perform one or more functions described in the present disclosure. For example, the processing engine 112 may determine a target vehicle based on the service request obtained from the requestor terminal 130. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the on-demand service system 100 (e.g., the server 110, the requestor terminal 130, the provider terminal 140, and the database 150) may send information and/or data to other component(s) in the on-demand service system 100 via the network 120. For example, the server 110 may obtain/acquire service request from the requestor terminal 130 via the network 120. In some embodiments, the network 120 may be any type of wired or wireless network, or combination thereof. Merely by way of example, the network 130 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-demand service system 100 may be connected to the network 120 to exchange data and/or information.

In some embodiments, a requestor may be a user of the requestor terminal 130. In some embodiments, the user of the requestor terminal 130 may be someone other than the requestor. For example, a user A of the requestor terminal 130 may use the requestor terminal 130 to send a service request for a user B, or receive service and/or information or instructions from the server 110. In some embodiments, a provider may be a user of the provider terminal 140. In some embodiments, the user of the provider terminal 140 may be someone other than the provider. For example, a user C of the provider terminal 140 may user the provider terminal 140 to receive a service request for a user D, and/or information or instructions from the server 110. In some embodiments, “requestor” and “requestor terminal” may be used interchangeably, and “provider” and “provider terminal” may be used interchangeably.

In some embodiments, the requestor terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, built-in device in the motor vehicle 130-4 may include an onboard computer, an onboard television, etc. In some embodiments, the requestor terminal 130 may be a device with positioning technology for locating the position of the requestor and/or the requestor terminal 130.

In some embodiments, the provider terminal 140 may be similar to, or the same device as the requestor terminal 130. In some embodiments, the provider terminal 140 may be a device with positioning technology for locating the position of the provider and/or the provider terminal 140. In some embodiments, the requestor terminal 130 and/or the provider terminal 140 may communicate with other positioning device to determine the position of the requestor, the requestor terminal 130, the provider, and/or the provider terminal 140. In some embodiments, the requestor terminal 130 and/or the provider terminal 140 may send positioning information to the server 110.

The database 150 may store data and/or instructions. In some embodiments, the database 150 may store data obtained from the requestor terminal 130 and/or the provider terminal 140. In some embodiments, the database 150 may store data and/or instructions that the server 110 may execute or use to perform exemplary methods described in the present disclosure. In some embodiments, database 150 may include a mass storage, a removable storage, a volatile read-and-write memory, a read-only memory (ROM), or the like, or any combination thereof. Exemplary mass storage may include a magnetic disk, an optical disk, a solid-state drives, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the database 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the database 150 may be connected to the network 120 to communicate with one or more components in the on-demand service system 100 (e.g., the server 110, the requestor terminal 130, the provider terminal 140, etc.). One or more components in the on-demand service system 100 may access the data or instructions stored in the database 150 via the network 120. In some embodiments, the database 150 may be directly connected to or communicate with one or more components in the on-demand service system 100 (e.g., the server 110, the requestor terminal 130, the provider terminal 140, etc.). In some embodiments, the database 150 may be part of the server 110.

In some embodiments, one or more components in the on-demand service system 100 (e.g., the server 110, the requestor terminal 130, the provider terminal 140, etc.) may have a permission to access the database 150. In some embodiments, one or more components in the on-demand service system 100 may read and/or modify information relating to the requestor, provider, and/or the public when one or more conditions are met. For example, the server 110 may read and/or modify one or more users' information after a service. As another example, the provider terminal 140 may access information relating to the requestor when receiving a service request from the requestor terminal 130, but the provider terminal 140 may not modify the relevant information of the requestor.

In some embodiments, information exchanging of one or more components in the on-demand service system 100 may be achieved by way of requesting a service. The object of the service request may be any product. In some embodiments, the product may be a tangible product, or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

FIG. 2 is a schematic diagram illustrating exemplary hardware and software components of a computing device 200 on which the server 110, the requestor terminal 130, and/or the provider terminal 140 may be implemented according to some embodiments of the present disclosure. For example, the processing engine 112 may be implemented on the computing device 200 and configured to perform functions of the processing engine 112 disclosed in this disclosure.

The computing device 200 may be a general purpose computer or a special purpose computer, both may be used to implement an on-demand system for the present disclosure. The computing device 200 may be used to implement any component of the on-demand service as described herein. For example, the processing engine 112 may be implemented on the computing device 200, via its hardware, software program, firmware, or a combination thereof. Although only one such computer is shown, for convenience, the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a central processing unit (CPU) 220, in the form of one or more processors, for executing program instructions. The exemplary computer platform may include an internal communication bus 210, program storage and data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, RAM 240, and/or other type of non-transitory storage medium to be executed by the CPU 220. The methods and/or processes of the present disclosure may be implemented as the program instructions. The computing device 200 also includes an I/O component 260, supporting input/output between the computer and other components therein such as user interface elements 280. The computing device 200 may also receive programming and data via network communications.

Merely for illustration, only one CPU and/or processor is described in the computing device 200. However, it should be note that the computing device 200 in the present disclosure may also include multiple CPUs and/or processors, thus operations and/or method steps that are performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

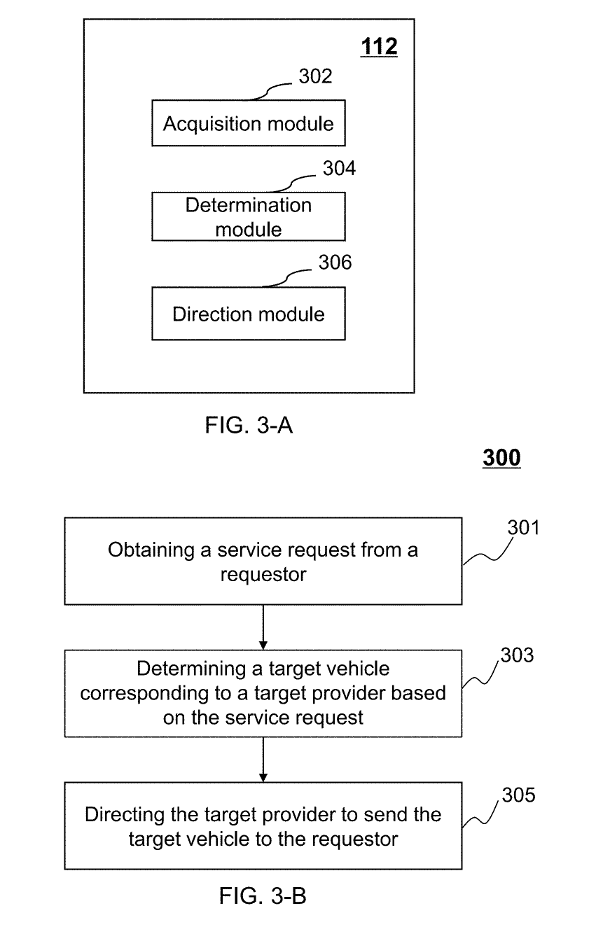

FIG. 3-A is a block diagram illustrating an exemplary processing engine 112 according to some embodiments of the present disclosure. The processing engine 112 may include an acquisition module 302, a determination module 304, and a direction module 306.

The acquisition module 302 may be configured to obtain a service request from a requestor. The service request may be a request for an authority to drive a vehicle by the requestor. The service request may include a start location, a destination, or an individualized definition of the vehicle, or the like, or any combination thereof. The destination may be an open destination, that is, the requestor may define no destination in the service request. The acquisition module 302 may obtain the service request from the requestor terminal 130 via the network 120. The service request may be transmitted to the determination module 304 or the direction module 306 to be further processed.

The determination module 304 may be configured to determine a target vehicle corresponding to a target provider based on the service request. The determination module 304 may determine the target vehicle based on the start location or the individualized definition of the service request.

The direction module 306 may be configured to direct the target provider to send the target vehicle to the requestor. In some embodiment, the direction module 306 may direct the target provider by sending information relating to the service request and/or the requestor to the provider terminal 140. For example, the direction module 306 may send a start location of the request and contact information of the requestor to the provider terminal 140 via the network 120.

In some embodiments, the processing engine 112 may further include an estimation module (not shown in FIG. 3-A). The estimation module may be configured to estimate a service fee based on the service request. In some embodiments, the estimation module may estimate the service fee based on the start location and destination of the service request. In some embodiments, the destination may be an open destination, the estimation module may just estimate a unit price based on the individualized definition of the service request.

The modules in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Any two of the modules may be combined as a single module, any one of the modules may be divided into two or more units.

FIG. 3-B is a flowchart illustrating an exemplary process/method 300 for determining a target vehicle/provider according to some embodiments of the present disclosure. The process/method 300 may be executed by the on-demand service system 100. For example, the process and/or method may be implemented as a set of instructions (e.g., an application) stored in the storage ROM 230 or RAM 240. The CPU 210 may execute the set of instructions and may accordingly be directed to perform the process and/or method 300.

In step 301, the processing engine 112 may obtain a service request from a requestor. The service request may be a request for an authority to drive a vehicle by the requestor.

Accordingly, the service request may include a start location (i.e., pickup location) where the requester will pick up the vehicle to start to drive. It may also define how the requestor wish to drive the vehicle. For example, the service request may define whether the drive is a test drive or a regular drive. Here, a test drive may be a driving activity that has a main purpose to exam performances of the vehicle defined by the requestor. Accordingly, the start location (e.g., a pickup location) of the service may be randomly distribute, depending on where the requester is, rather than in a fixed location, such as where a car rental company's location. Further, the requester (e.g., test driver) may or may not have in his mind a determined destination and/or driving route of his trip, or the destination may be the same location as the start location, so that the request may drop off the target vehicle at the same place he/she picks up the target vehicle. The driving time normally may last only a few minutes. In some scenario when the driver merely wishes to see the appearance of a particular vehicle model, or does not feel good to the vehicle model he/she selected, the driver may even refuse to drive the vehicle. In a regular drive, the driver's main purpose may be transportation. Therefore, the driver may have a predetermined destination and/or driving route.

In some embodiments, the start location may be a current location of the requestor which may be obtained by the requestor terminal 130 (e.g., by a Global Position System (GPS) in the requestor terminal 130), or may be defined by the requestor. The destination may be defined by the requestor or may be open. As used herein, “open” may refer to that it is unnecessary for the requestor to predetermine a specific destination.

In some embodiments, the service request may include a real-time request and/or an appointment request. As used herein, a real-time request may be a request that the requestor wishes to drive the vehicle at the present moment or at a defined time reasonably close to the present moment for an ordinary person in the art. For example, a request may be a real-time request if the defined time is shorter than a threshold value, such as 1 minute, 5 minutes, 10 minutes or 20 minutes. The appointment request may refer to that the requestor wishes to drive the vehicle at a defined time which is reasonably far from the present moment for the ordinary person in the art. For example, a request may be an appointment request if the defined time is longer than a threshold value, such as 20 minutes, 2 hours, or 1 day. In some embodiments, the processing engine 112 may define the real-time request or the appointment request based on a time threshold. The time threshold may be default settings of the system 100, or may be adjustable depending on different situations. For example, in a traffic peak period, the time threshold may be relatively small (e.g., 10 minutes), otherwise in idle period (e.g., 10:00-12:00 am), the time threshold may be relatively large (e.g., 1 hour).

Further, the service request may include individualized and/or personalized definition to the vehicle that the requestor wishes to drive. For example the system 100 may allow the user to input preference parameters to set the requestor's personal requirements to the vehicle, such as a vehicle brand, a vehicle model, an overall dimension of the required vehicle, an inner dimension of the required vehicle, a driving type (e.g., front wheel drive, rear wheel drive, or four wheel drive) of the required vehicle, a displacement of the required vehicle, a gear box settings (e.g., manual transmission or automatic transmission) of the required vehicle, a clutch of the required vehicle, a fuel tank of the required vehicle, a brake system (e.g., anti-lock breaking system) of the required vehicle, a steering system of the required vehicle, a self-driving system of the required vehicle, an air conditioning of the required vehicle, an audio system of the required vehicle, a lamp of the required vehicle, a seat of the required vehicle, a maximum speed of the required vehicle, a horse power of the required vehicle, a vehicle age of the required vehicle, a color of the required vehicle, a painting of the required vehicle, a decoration (e.g., inner decoration such as black leather seat) of the required vehicle, a muffler of the required vehicle, new energy (e.g., electrical car or hybrid car) of the required vehicle, or the like, or any combination thereof. One of ordinary skill in the art would understand that the requirements to the vehicle parameter may cover any aspect of a vehicle that a person may be particularly interested in.

The above preference parameters may be manually input by the requestor. Alternatively, the system 100 may provide a complete set of vehicle parameters to the user so that the user may define the vehicle by selecting one or more of the parameters. The system 100 may assign to each of the vehicle parameter with a default value, and then allow the requestor to change these parameters to his/her preference values. For example, for a BMW model, the system 100 may automatically assign the corresponding vehicle parameters with settings based on the standard settings of the vehicle model. For example, based on the standard setting, the system 100 may automatically set automatic transmission to 2005 BMW 324 Ci. The requester may change this setting to manual transmission as he/she wishes. Further, the system 100 may also assign a weight value, which reflects how important the parameter is, to each of the vehicle parameters. For example, the system 100 may assign a higher weight to a vehicle's interior decoration than the vehicle's muffler type.

In some embodiments, the processing engine 112 may collect personal information relating to the requestor from the requestor terminal 130 or the database 150, and determine eligibility information of the requestor. The personal information may include identification (hereafter referred to as “ID”), driver license of the requestor, a type of the driver license, validity term of the driver license, or the like, or a combination thereof. The type of driver license may include A1 (driver license for large-sized coach), A2 (driver license for tractor), A3 (driver license for city bus), B1 (driver license for medium-sized coach), B2 (driver license for medium-sized trucks), C1 (driver license for small-sized coach), C2 (driver license for small automatic shift coach), or C3 (driver license for low speed carriage vehicle). The eligibility information may refer to that whether the requestor has a qualification to drive a vehicle. For example, if no driver license is uploaded when the requestor registers with the on-demand service system 100, the processing engine 112 may determine that the requestor has no qualification to drive a vehicle. In this situation, the processing engine 112 may reject the service request or may provide a notification to the requestor. For example, the processing engine 112 may provide a notification to alert the requestor to upload a driver license. As another example, the processing engine 112 may compare the ID of the requestor with ID information relating to the driver license of the requestor, if the two is consistent with each other, the processing engine 112 may determine that the requestor has a qualification to drive a vehicle; if not consistent, the processing engine 112 may reject the service request or may provide a notification to the requestor. For example, the processing engine 112 may provide a notification to revise the ID or the driver license.

In some embodiments, the method/process for determining the eligibility information may be performed when a user tries to register with the on-demand service system 100 as a requestor. For example, if no driver license is uploaded when the user tries to register with the on-demand service system 100, the processing engine 112 may reject the registration or may provide a notification to the user to remind him/her to upload the driver license within a time threshold (e.g., 24 hours). As another example, if the ID of the user and the ID information relating to the driver license that is uploaded by the user are not consistent, the processing engine 112 may reject the registration or may provide a notification to the user to revise the ID or the driver license.

In step 303, the processing engine 112 may determine a target vehicle corresponding to a target provider based on the service request. In some embodiments, the processing engine 112 may determine a vehicle whose location is the nearest to the start location of the service request as the target vehicle. In some embodiments, the processing engine 112 may determine the target vehicle based on the individualized definition of the service request. For example, if in the individualized definition of the service request, the requestor defines a certain vehicle brand (e.g., BMW) and a certain color (e.g., red), the processing engine 112 may determine the target vehicle which matches the definitions above.

In some embodiments, the processing engine 112 may collect personal information relating to the provider from the provider terminal 130 or the database 150, and determine eligibility information of the provider. As mentioned above, similar with determining the eligibility information of the requestor, the processing engine 112 may analyze the ID or the information relating to the driver license of the provider, and determine whether the provider has a qualification to drive a vehicle.

In step 305, the processing engine 112 may direct the target provider to send the target vehicle to the requestor. In some embodiments, the processing engine 112 may send information relating to the service request and/or the requestor to the provider terminal 140. The information relating to the service request and/or the requestor may include the start location, the destination (which may or may not be defined by the requestor), name of the requestor, contact information of the requestor (e.g., cell phone number), or the like, or a combination thereof. The target provider may contact the requestor to confirm the start location, appoint a pick-up time, or ask the requestor whether he/she has any other additional requirement. In some embodiments, the processing engine 112 may provide a navigation service for the target provider on the provider terminal 140. For example, the processing engine 112 may determine a location of the target vehicle, determine a distance between the location of the target vehicle and the start location, determine a route from the location of the target vehicle to the start location, display the location of the target vehicle, the start location, and the route on a map (e.g., a Tencent map) on the provider terminal 140. While on the way to send the target vehicle to the requestor, the processing engine 112 may provide one or more notifications for the target provider. The notification may be associated with a speed limit, a traffic light, a road condition, or the like, or a combination thereof. In some embodiments, the target provider may set a navigation preference via the provider terminal 140. The navigation preference may include a volume of a navigation voice, a display effect associated with the road condition (e.g., read for traffic congestion, green for smooth), nearby entertainment, or the like, or a combination thereof.

In some embodiments, when the requestor sends a service request, the processing engine 112 may estimate a service fee based on the service request. The service request may define a certain vehicle, the processing engine 112 may determine a basic fee of the certain vehicle. For example, if the service request defined a start location and a destination, the processing engine 112 may estimate a travel fee by a billing model based on the start location and the destination. The billing model includes a starting price, a unit price beyond the range of the starting price, or a waiting fee due to a red light or traffic congestion. Then the processing engine 112 may estimate a total service fee by combining the basic fee and the estimated travel fee, and send the estimated service fee to the requestor terminal 130. If the service request didn't define a destination, the processing engine 112 may provide the basic fee and the billing model to the requestor terminal 130. The processing engine 112 may also send the basic fee and the billing model to the provider terminal 140. When the service request is completed, the processing engine 112 may determine an actual service fee based on the billing model and generate a bill based on the actual service fee. The processing engine 112 may send the bill to the requestor terminal 130, then the requestor may complete a payment via the requestor terminal 130.

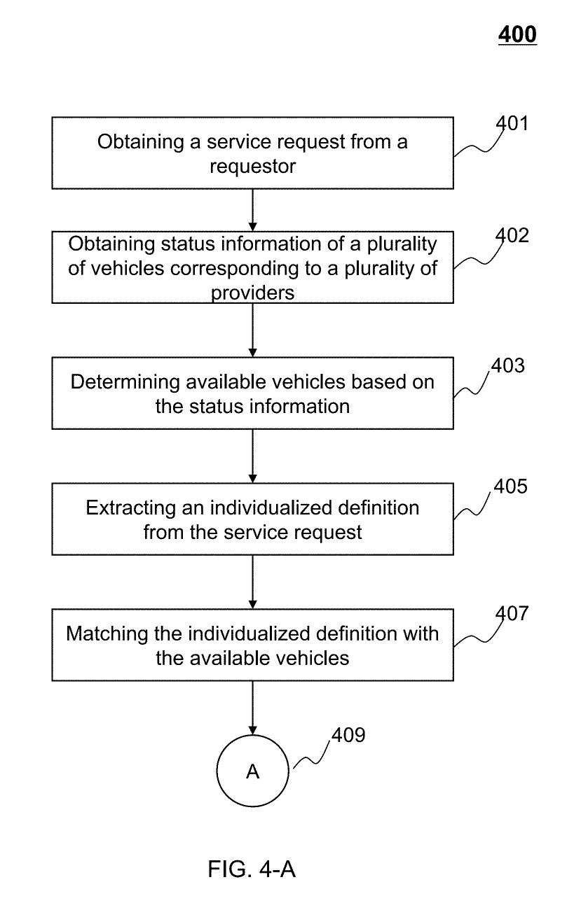

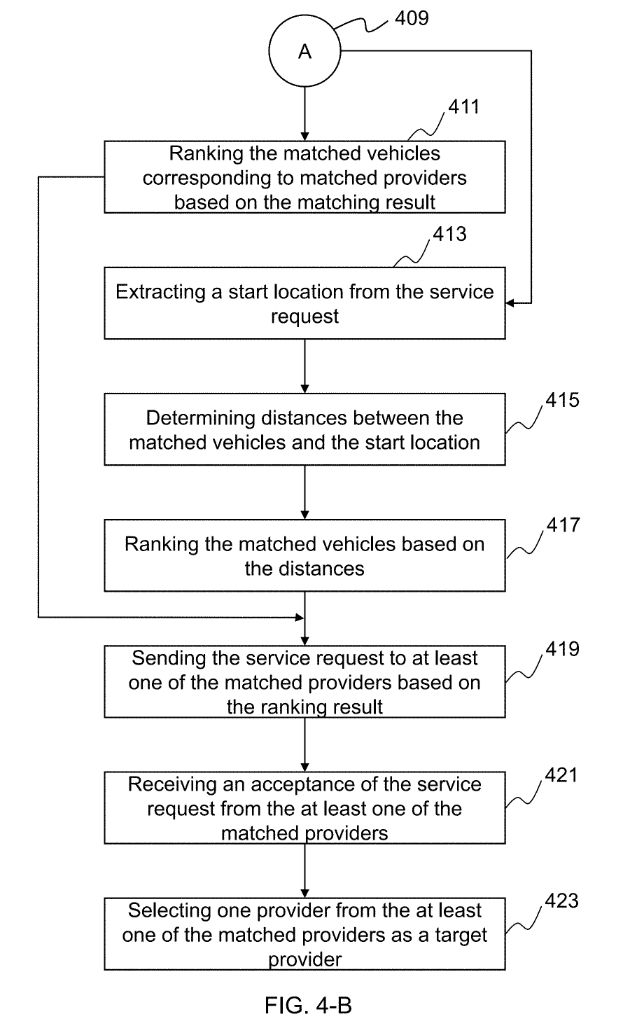

FIG. 4 is a flowchart illustrating an exemplary process/method 400 for determining a target vehicle/provider according to some embodiments of the present disclosure. The process and/or method 400 may be executed by the on-demand service system 100. For example, the process and/or method may be implemented as a set of instructions (e.g., an application) stored in the storage ROM 230 or RAM 240. The CPU 210 may execute the set of instructions and may accordingly be directed to perform the process and/or method 400.

In step 401, the processing engine 112 may obtain a service request from a requestor. As described in connection with step 301, the service request may be a request for an authority to drive a vehicle by the requestor. The service request may include a start location and an individualized definition.

In step 402, the processing engine 112 may obtain status information of a plurality of vehicles corresponding to a plurality of providers. In some embodiments, the plurality of vehicles may be determined within a predefined region. The predefined region may include an administrative area (e.g., a district in a city), or a geographical region (e.g., within a certain radius from a defined center location). For example, for a real-time request, the processing engine 112 may obtain a current location of the requestor and determine a geographical region within a certain predetermined radius (e.g., 10 km) from the current location of the requestor. Value of the predetermined radius may vary depending on the current location of the requestor. For example, the predetermined radius may be smaller (e.g., 3 km) if the current location of the requestor is in a highly populated area (e.g., Manhattan of New York City), whereas the predetermined radius may be larger (e.g., 20 km) if the current location of the requestor is in a less populated area (e.g., a rural area).

In some embodiments, the status information may include an available status or an unavailable status. The available status may refer to a status that a service provider is available to provide a requested service; the unavailable status may refer to a status that the service provider is unavailable to provide the requested service. In some embodiments, the processing engine 112 may communicate with a plurality of provider terminals 140 via the network 120 to obtain the status information of the plurality of vehicles. In some embodiments, the available status may include a current available status, a future available status, or the like, or any combination thereof. As used herein, the current available status may refer to that the provider is able to provide a service (i.e. send the vehicle to the requestor) at the present moment. The future available status may refer to that the provider may be able to provide a service at a future time that is determined by the provider. For example, the provider may define a status setting to provide a service on weekends or provide a service after 6:00 p.m. every day next week.

Merely by way of example, the processing engine 112 may retrieve the status setting defined by the provider and determine the status information of the corresponding vehicle based on the status setting. As another example, for a specific vehicle, if the corresponding provider terminal 140 is online and there is no specific status setting defined by the provider, the processing engine 112 may determine that the status information of the specific vehicle is current available status. As a further example, for a specific vehicle, if the corresponding provider terminal 140 is offline, and the provider has set that the provider terminal 140 may receive request via an information push mode (i.e. the requests may be pushed to the provider terminal 140 by emails, text messages, social software messages when the provider is offline), the processing engine 112 may determine that the status information of the specific vehicle is current available status.

In some embodiments, the unavailable status may include an occupied status of the vehicle, an expiration of vehicle inspection, an expiration of driver license of the provider, or the like, or any combination thereof. As used herein, the occupied status of the vehicle may refer to that the provider is providing a service for a certain requestor at the present moment (e.g., the provider is on the way to send the vehicle to the certain requestor, or the certain requestor is driving the vehicle).

In step 403, the processing engine 112 may determine available vehicles based on the status information. For example, for a real-time request, the available vehicles may refer to the vehicles in the current available status. As another example, for an appointment request, the available vehicles may refer to the vehicles in the current available status or the vehicles in the future available status.

In step 405, the processing engine 112 may extract the individualized definition from the service request. In some embodiments, the individualized definition may include one or more of the preference parameters relating to the required vehicle. In some embodiments, the preference parameters may be given different priorities. For example, the requestor wishes to drive a BMW vehicle which preferably has a high horse power, the vehicle brand may be given a first priority and the horse power may be given a secondary priority.

In step 407, the processing engine 112 may match the individualized definition with the available vehicles. In some embodiments, the processing engine 112 may match the individualized definition with vehicle information of the available vehicles. The vehicle information may correspond to the preference parameters in the individualized definition. The vehicle information may be expressed by text, picture, audio, video, or the like, or a combination thereof. For example, the processing engine 112 may obtain the vehicle information via the network 120 from a written description provided by the provider when the provider register the vehicle via the provider terminal 140. If the vehicle information is the same or similar with the preference parameters, the processing engine 112 may determine the corresponding vehicle as a candidate vehicle.

In some embodiments, when the preference parameters are accurately defined by the requestor (e.g., BMW, red color) in the individualized definition, the processing engine 112 may match the preference parameters with the vehicle information one by one. For example, if in the individualized definition, the requestor defines a vehicle brand “BMW” and a color “red”, the processing engine 112 may first match the vehicle brands of the available vehicles with the defined vehicle brand “BMW” and determine one or more vehicles with the defined vehicle brand “BMW” (e.g., 10 BMW vehicles); and next the processing engine 112 may match the colors of the one or more vehicles with the defined color “red” and determine one or more vehicles with the defined color “red” as the candidate vehicles (e.g., 3 red BMW vehicles).

In some embodiments, when one or more preference parameters are accurately defined and one or more preference parameters are defined by a range (e.g., high horse power) in the individualized definition, the processing engine 112 may first match the accurately defined preference parameters with the vehicle information one by one, and next match the preference parameters defined by a range. For example, if in the individualized definition, the requestor defines a vehicle brand “BMW” and a horse power “high horse power”, the processing engine 112 may first match the vehicle brands of the available vehicles with the defined vehicle brand “BMW” and determine one or more vehicles with the defined vehicle brand “BMW” (e.g., 10 BMW vehicles); and next the processing engine 112 may compare the horse powers of the one or more vehicles with a horse power threshold value (e.g., 150), and determine one or more vehicles with the defined vehicle brand “BMW” and the horse power higher than the horse power threshold value as the candidate vehicles (e.g., 6 BMW vehicles with the horse power higher than 150). As used herein, the horse power threshold value may be default settings of the system 100, or may be predefined by the requestor in the individualized definition.

According to embodiments of the present disclosure, the system 100 may also use the weight values of the each vehicle parameter to the individualized definition with the available vehicles. When evaluating a vehicle available to provide the required service, the system 100 may add the weight values of all parameters that meet the parameter requirements, and then obtain an overall score of the vehicle to be evaluated. The overall score may reflect how well a vehicle available to provide the required service matches the preference parameter requirements of the requester.

After the system 100 matches the individualized definition with the available vehicles, the system 100 may execute the process/method 400 to node A 409 and perform at least some of steps starting from node A 409 illustrated in FIG. 4-B.

In step 411, the processing engine 112 may rank the candidate vehicles corresponding to candidate providers based on the matching result, and generate a first ranking result.

For example, if in the individualized definition, the requestor defined a vehicle brand “BMW” and a horse power “high horse power”, the processing engine 112 may rank the candidate vehicles based on the values of the horse powers from high to low. After the processing engine 112 ranks the candidate vehicles, the processing engine 112 may execute the process/method 400 to step 419 to send the service request to at least one of the candidate providers based on the ranking result.

According to embodiments of the present disclosure, the system 100 may also rank all vehicles available to provide the required service based on their respective overall scores. And then, the system 100 may select those that have overall scores higher than a predetermined value, and/or select the top predetermined number of vehicles in the ranking. These selected vehicles may then be treated as candidate vehicles to recommend and/or display to the requester.

In step 413, the processing engine 112 may extract the start location from the service request. As used herein, for a real-time request, the start location (i.e., the pickup location) may be a current location of the requestor. For an appointment request, the start location may be a defined location by the requestor. In some embodiments, the processing engine 112 may extract the start location by a Global Position System (GPS) in the requestor terminal 130. In some embodiments, the requestor may input the start location via the requestor terminal 130, and then, the processing engine 112 may retrieve the start location from the service request.

In step 415, the processing engine 112 may determine distances between the candidate vehicles and the start location. For example, the processing engine 112 may obtain a location of a certain candidate vehicle by a GPS in a corresponding provider terminal 140 (i.e., candidate provider terminal) or a driving recorder of the certain candidate vehicle. The processing engine 112 may determine a distance between the certain candidate vehicle and the start location.

In step 417, the processing engine 112 may rank the candidate vehicles based on the distances, for example, from small to large, and generate a second ranking result. In some embodiments, as described above, in step 411, the processing engine 112 may rank the candidate vehicles based on the matching result (e.g., overall score) and generate the first ranking result. Under this situation, the processing engine 112 may combine the first ranking result and the second ranking result to generate a third ranking result. For example, the processing engine 112 may assign different weighting coefficients to the first ranking result and the second ranking result, and generate the third ranking result based on the weighting coefficients. In some embodiments, the weighting coefficients may be default settings of the system 100 or may be set by the requestor.

Merely by way of example, as illustrated in Table 1 below, if the weighting coefficient for the first ranking result is 0.6, and the weighting coefficient for the second ranking result is 0.4, the processing engine 112 may determine third ranking values based on the weighting coefficients, and then, the processing engine 112 may determine the third ranking result based on the third ranking values.

TABLE 1
a schematic combined ranking result

| | First ranking | Second ranking | Third ranking | Third ranking |
|---|---|---|---|---|
| Vehicle | result | result | value | result |
| A | 1 | 5 | 2.4 | 3 |
| B | 2 | 1 | 1.2 | 1 |
| C | 3 | 2 | 2 | 2 |
| D | 4 | 3 | 2.8 | 4 |
| E | 5 | 4 | 3.6 | 5 |

In step 419, the processing engine 112 may send the service request to at least one of the candidate providers based on the ranking result (e.g., the first ranking result, the second ranking result, or the third ranking result), and each of the candidate provider is associated with a candidate vehicle For example, the processing engine 112 may send the service request to the first N candidate providers (e.g., 3) according to the second ranking result, where N is a positive integer. As another example, the processing engine 112 may predetermine a distance threshold (e.g., 5 km) and send the service request to first N′ candidate providers within the distance threshold from the start location. In some embodiments, the value of N or N′ may be default settings of the system 100 or may be adjusted under different situations. For example, for the real-time request or the appointment request, the values of N may be different.

In step 421, the processing engine 112 may receive an acceptance of the service request from the at least one of the candidate providers. In some embodiments, the processing engine 112 may receive the acceptance from the provider terminal 140 via the network 120.

In step 423, the processing engine 112 may select one provider from the at least one of the candidate providers as a target provider. Accordingly, a target vehicle may be determined corresponding to the target provider. In some embodiments, the processing engine 112 may select a provider as the target provider based on the ranking result. For example, if the processing engine 112 receives 3 acceptances from the candidate providers, the processing engine 112 may select a provider corresponding to a vehicle which has a higher ranking than the other 2 candidate vehicles as the target provider. In some embodiments, the processing engine 112 may send the selection result to the provider terminal 140 and/or the requestor terminal 130 via the network 120. In some embodiments, the processing engine 112 may further send information relating to the target vehicle or the target provider to the requestor terminal 130. In some embodiments, the information relating to the target vehicle or the target provider may include a vehicle photo, a vehicle location, driver information, an estimated fee of the service request, a vehicle price, or the like, or any combination thereof. After the processing engine 112 determines the target vehicle, the processing engine 112 may change status information of the target vehicle from an available status to an unavailable status (e.g., occupied status).

In some embodiments, before the processing engine 112 selects the target vehicle/provider, the requestor may cancel the service request. The processing engine 112 may terminate the process/method for determine a target vehicle/provider. In some embodiments, after the processing engine 112 determines the target vehicle/provider, the requestor may cancel the service request. The processing engine 112 may update the status of the target vehicle as an available status.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, step 405 may be performed before steps 401, 402 and 403. As a further example, if the preference parameters are accurately defined by the requestor (e.g., BMW, red color) in the individualized definition, step 411 may be optional.

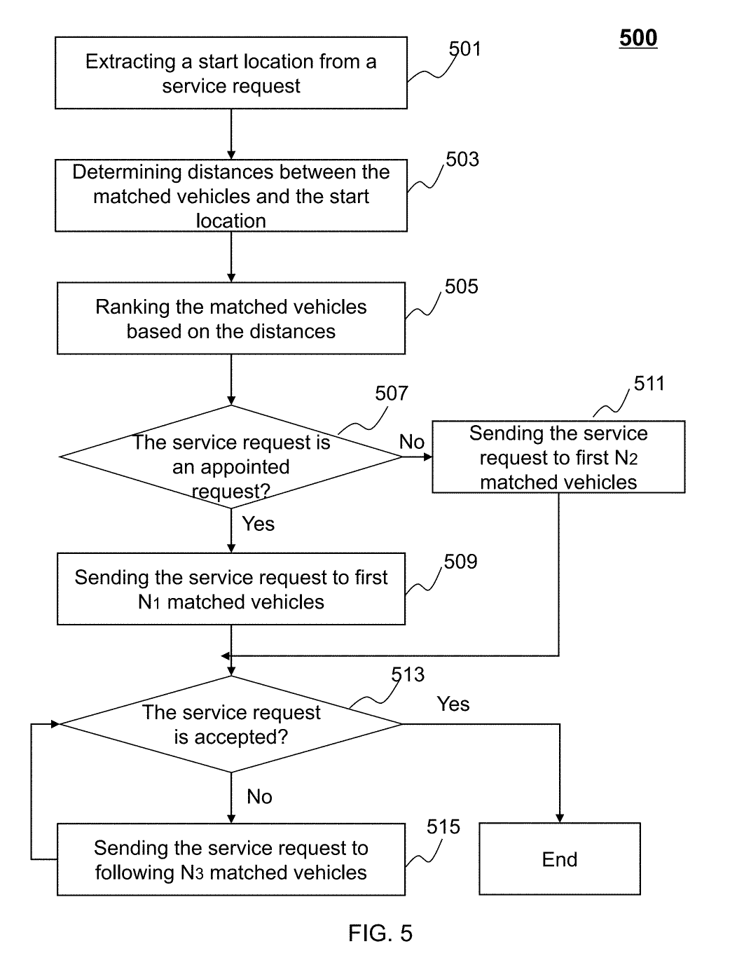

FIG. 5 is a flowchart illustrating an exemplary process/method 500 for sending a service request to one or more candidate vehicles according to some embodiments of the present disclosure. The process/method 500 may be executed by the on-demand service system 100. For example, the process and/or method may be implemented as a set of instructions (e.g., an application) stored in the storage ROM 230 or RAM 240. The CPU 210 may execute the set of instructions and may accordingly be directed to perform the process and/or method 500.

In step 501, the processing engine 112 may extract and/or obtain a start location from a service request from a requestor. As described in connection with step 413, the start location may be a current location of the requestor or a defined location by the requestor.

In step 503, as described in connection with step 415, the processing engine 112 may determine distances between the candidate vehicles and the start location. As described elsewhere in the present disclosure, the candidate vehicles may refer to the vehicles matched with the service request. In some embodiments, the processing engine 112 may retrieve locations of the candidate vehicles via the GPSs in the provider terminals 140 of the candidate providers. In some embodiments, the processing engine 112 may determine the distances based on map data (e.g., map coordinates) from the database 150 or an external map (e.g., a Tencent Map, a Google Map, a Bing Map).

In step 505, the processing engine 112 may rank the candidate vehicles based on the distances and generate a ranking result, for example, from small to large, or from large to small.

In step 507, the processing engine 112 may determine whether the service request is an appointment request. If so, the processing engine 112 may send the service request to first N₁ candidate vehicles according to the ranking result. If not (or the service request is a real-time request), the processing engine 112 may send the service request to first N₂ candidate vehicles according to the ranking result. As used herein, N₁ and N₂ may be positive integers. For example, N₂ may be equal to 1, N₁ may be larger than or equal to N₂ (e.g., 5). In some embodiments, N₁ and/or N₂ may be default settings of the system 100, or may be adjusted under different situations. For example, if the service request is an appointment request, in traffic peak period, the value of N₁ may be 10, while in idle period, the value of N₁ may be 20.

In step 513, the processing engine 112 may define a first time threshold (e.g., 30 s), after the service request is sent to the candidate vehicles, the processing engine 112 may determine whether the service request is accepted within the first time threshold. If so, the processing engine 112 may execute the process/method 500 to end. If not, the processing engine 112 may send the service request to following N₃ candidate vehicles according to the ranking result in step 515. Then the processing engine 112 may execute the process/method 500 back to step 513, until the service request is accepted, the processing engine 112 may execute the process/method 500 to end. As used herein, N₃ may be a positive integer. In some embodiments, N₃ may be larger than or equal to N₁ or N₂. In some embodiments, N₃ may be adjusted according to time or traffic conditions. For example, on weekends, the value of N₃ may be 20, while on weekends or in public holidays, the value of N₃ may be 30. As another example, in traffic peak period, the value of N₃ may be 20, while in idle period, the value of N₃ may be 30.

In some embodiments, the processing engine 112 may determine a time interval between a time point of sending the service request and current time. The processing engine 112 may define a second time threshold (e.g., 30 minutes), if the time interval is greater than the second time threshold and within the time interval no acceptance is received, the processing engine 112 may determine that the service request is cancelled. In some embodiments, the processing engine 112 may provide a notification to notify the requestor to determine whether to resend the service request. The second time threshold may be default settings of the on-demand service system 100, or may be adjusted by the requestor.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, when the service request is not an appointment request, step 513 may be optional.

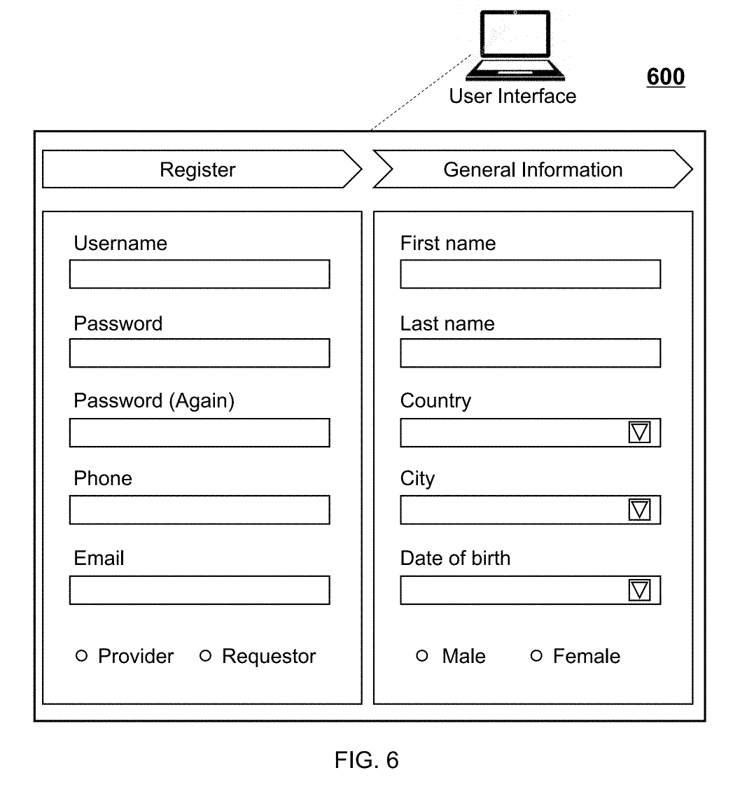

FIG. 6 is a schematic diagram illustrating an exemplary user interface 600 for user registration according to some embodiments of the present disclosure. The user interface 600 may be shown on the requestor terminal 130 or the provider terminal 140 when a user (e.g., a requestor, a provider) first registers with the on-demand system 100. In some embodiments, the user (e.g., a requestor, a provider) may also return to the user interface 600 to modify the registration information if necessary. For example, if the user moves to another city or changes a new phone number, the user may return to the user interface 600 to modify the corresponding information.

On the user interface 600 for user registration, the user (e.g., the requestor, the provider) may input a username, a password, contact information (e.g., a phone number, an email address), general information (e.g., a first name, a last name, a country, a city, a date of birth, a gender (e.g., a male, a female)), or the like, or a combination thereof. In some embodiments, the contact information or the general information may be optional. In some embodiments, the information may be inputted by the user or may be chosen by the user from a plurality of default options set by the on-demand service system 100.

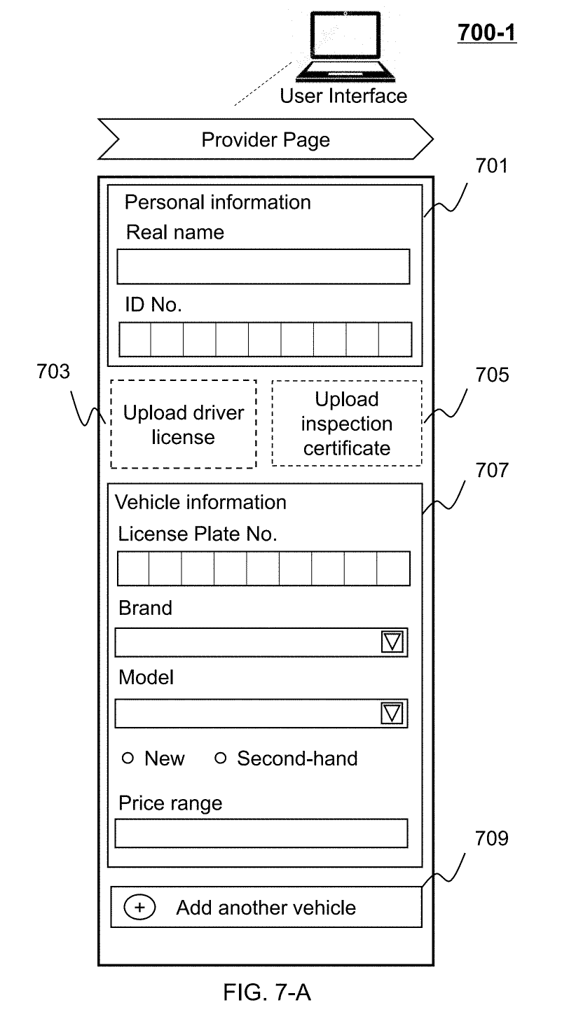

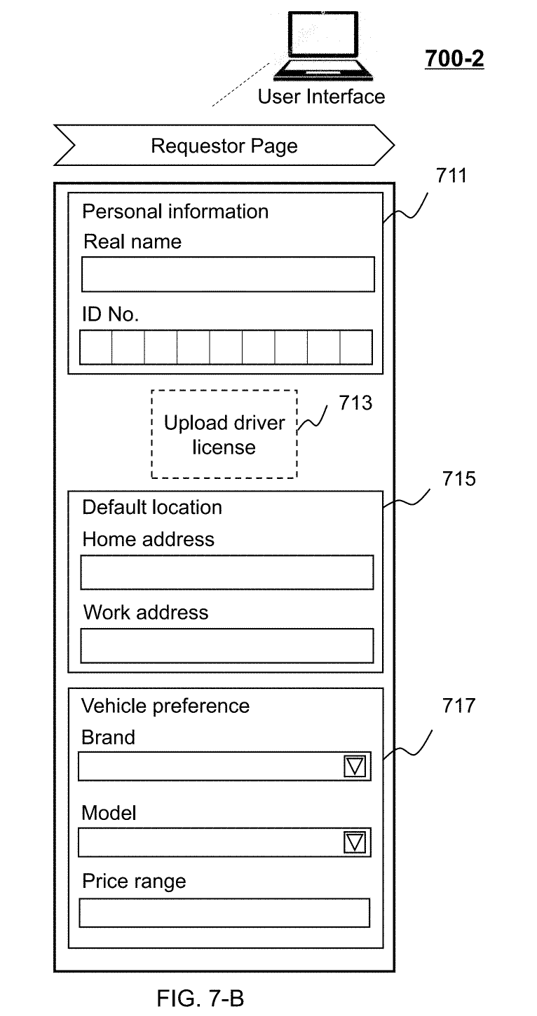

In the bottom or the top of the user interface 600, two checkboxes (e.g., a “provider” checkbox and a “requestor” checkbox) may be provided. The user may choose to register as a requestor or a provider by checking a corresponding checkbox. In some embodiments, the user may register as both a requestor and a provider at the same time by checking the two checkboxes. For example, when the user checks the “requestor” checkbox on the user interface 600, a requestor page 700-2 (as shown in FIG. 7-B) may be shown to the user. As another example, when the user checks both the “provider” checkbox and the “requestor” checkbox on this interface, a provider page 700-1 (as shown in FIG. 7-A) and the requestor page 700-2 may be both shown to the user.

FIG. 7-A illustrates an exemplary provider page 700-1 for provider registration, and FIG. 7-B illustrates an exemplary requestor page 700-2 for requestor registration. The provider page 700-1 and/or the requestor page 700-2 may be shown on the requestor terminal 130 or the provider terminal 140 according to the provider option and/or the requestor option chosen by the user on the user interface 600 shown in FIG. 6.

As illustrated in FIG. 7-A, in the provider page 700-1, the user may input personal information (e.g., a real name, an ID number) via a solid box 701. In some embodiments, the user may input the personal information by uploading a picture of the user's ID card. In some embodiments, the processing engine 112 may check the personal information. For example, the processing engine 112 may check whether the real name is consistent with the ID number. If not consistent, the processing engine 112 may reject the registration of the user.

In some embodiments, the user may upload a driver license or an inspection certificate. For example, the user may upload a picture of the driver license via a dashed box 703 and upload a picture of the inspection certificate via a dashed box 705. In some embodiments, the processing engine 112 may check the quality of the pictures uploaded by the user. For example, the processing engine 112 may check whether the text or number in the picture is clear and distinguishable.

In some embodiments, the user may input vehicle information via a solid box 707 illustrated in FIG. 7-A. The vehicle information may include a license plate No., a vehicle brand, a vehicle model, a price range, or the like, or a combination thereof. In addition, the user may input whether the vehicle is a new vehicle or a second-hand vehicle by checking a “new” checkbox or a “second-hand” checkbox. The vehicle brand and the vehicle model may be inputted by the user or may be chosen by the user from a plurality of default options set by the on-demand service system 100. The price range may be default settings of the on-demand service system 100, or may be adjusted by the user. For example, if the user checks the “new” checkbox, the price range may be a default setting relating to the vehicle brand and vehicle model. If the user checks the “second-hand” checkbox, the price range may be adjusted by the user. In some embodiments, the vehicle information may include one or more pictures of the vehicle (e.g., front view, side view, top view, details). In some embodiments, the user may add another vehicle via a “+” icon illustrated in a solid box 709 in FIG. 7-A.

As illustrated in FIG. 7-B, in the requestor page 700-2, the user may input personal information (e.g., a real name, an ID number) via a solid box 711. In some embodiments, the user may input the personal information by uploading a picture of the user's ID card. In some embodiments, the processing engine 112 may check the personal information. For example, the processing engine 112 may check whether the real name is consistent with the ID number. If not consistent, the processing engine 112 may reject the registration of the user.

In some embodiments, the user may upload a driver license. For example, the user may upload a picture of the driver license via a dashed box 713. In some embodiments, the processing engine 112 may check the quality of the pictures uploaded by the user. For example, the processing engine 112 may check whether the text or number in the picture is clear and distinguishable.

In some embodiments, the user may input default locations (e.g., a home address, a work address) via a solid box 715. In some embodiments, when the user tries to input the home address or the work address, the processing engine 112 may allow a map to appear on the requestor page 700-2. The user may define an address by determining a point on the map. The processing engine 112 may determine a current location via the map and provide a notification to notify the user to determine whether defines the current location as the home address or the work address. For example, on workdays, the processing engine 112 may notify the user to determine whether defines the current location as the work address, while on weekends or public holidays, the processing engine 112 may notify the user to determine whether defines the current location as the home address.

In some embodiments, the user may input vehicle preference via a solid box 717 illustrated in FIG. 7-A. The vehicle preference may include a vehicle brand, a vehicle model, a price range, or the like, or any combination thereof. The vehicle preference may also include detailed requirements to the vehicle such as an overall dimension, an inner dimension, a transmission type, a displacement, a gear box, a clutch, a fuel tank, a brake system, a steering system, a self-driving system, an air conditioning, an audio system, a lamp, a seat, a maximum speed, a horse power, a vehicle age, a color, a painting, a decoration, a silencer, new energy, or the like, or any combination thereof. The vehicle brand and the vehicle model may be inputted by the user or may be chosen by the user from a plurality of default options set by the on-demand service system 100. In some embodiments, as described in connection with FIG. 4, when the requestor wishes to define the individualized definition relating to the required vehicle in the service request, the requestor may directly choose the vehicle preference as the preference parameters in the individualized definition.

In some embodiments, the provider page 700-1 and the requestor page 700-2 may be on a same page. In this situation, the user may reach a page region (e.g. personal information, vehicle information, vehicle preference) by dragging a scroll box along a scroll bar.

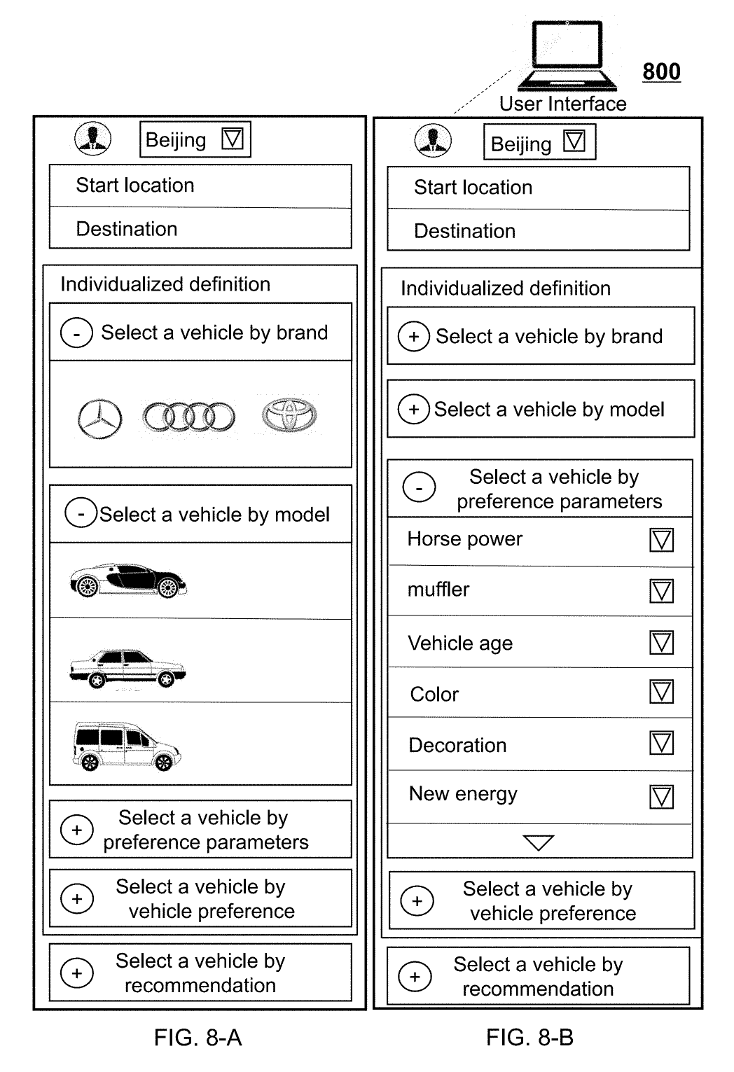

FIGS. 8-A and 8-B are schematic diagrams illustrating an exemplary user interface 800 for requestor usage according to some embodiments of the present disclosure. The user interface 800 for requestor usage may be shown on the requestor terminal 130 when the requestor wishes to send a service request.

As illustrated in FIG. 8-A and FIG. 8-B, on this user interface 800, the requestor may input the start location via a “start location” box, the destination via a “destination” box, and the individualized definition of the service request via an “individualized definition” box. In some embodiments, the requestor may define a current location via the GPS in the requestor terminal 130 as the start location. In some embodiments, when the requestor tries to input the start location, the processing engine 112 may provide a dialog box on the user interface 800. The requestor may determine the default location (e.g., the home address or the work address illustrated in FIG. 7-B) as the start location via the dialog box. The requestor may leave the “destination” box empty which reflects that the destination is open and the requestor wishes to drive a vehicle without a distance limit.

For illustration purposes, the requestor may define the individualized definition by selecting a vehicle by a vehicle brand, a vehicle model, preference parameters, or the vehicle preference (defined at registration). It may be seen that in FIG. 8-A and FIG. 8-B, different sections of the user interface 800 are folded. The requestor may unfold the folded sections by clicking the “+” icon, and fold the sections by clicking the “−” icon.

As illustrated in FIG. 8-A, the requestor may define the individualized definition by defining a vehicle brand. In some embodiments, a plurality of trademarks of vehicle brands may be shown on the user interface 800. The requestor may select a vehicle brand by clicking a corresponding trademark. After the requestor selects a certain vehicle brand, a list of vehicles may be shown on the requestor terminal 130. Further, the requestor may define the individualized definition by defining a vehicle model. In some embodiments, a plurality of pictures of vehicle models may be shown on the user interface 800. The requestor may select a vehicle model by clicking a corresponding picture. After the requestor selects a certain vehicle model, a list of vehicles may be shown on the requestor terminal 130.

As illustrated in FIG. 8-B, the requestor may define the individualized definition by defining one or more preference parameters. For illustration purposes, a horse power, a muffler, a vehicle age, a decoration, and a new energy are shown. The requestor may view more preference parameters by clicking a pull down icon (“∇”). In some embodiments, the preference parameters may be inputted by the requestor or may be chosen by the requestor from a plurality of default options set by the on-demand service system 100. In some embodiments, it is unnecessary for the requestor to determine all the preference parameters listed on the user interface 800. The requestor may define the any of the preference parameters if needed.

Further, the requestor may select a vehicle by a recommendation. As used herein, a recommendation may refer to vehicle information relating pushed by the system 100. The processing engine 112 may determine the recommendation according to the requestor's historical data or statistical data relating to a peer group. For example, the processing engine 112 may collect user profile of all or portion of users registered in the on-demand service system 100 and extract their respective historical user's presences. The on-demand service system 100 may then establish a hierarchical database (e.g., the database 150), wherein the users are statistically divided under various characteristics. For example, the on-demand service system 100 may categorize a user based on his/her demographic profile such as age, gender, education level, hobby, income level, occupation, etc. As used herein, a peer group is defined as a group of people sharing at least some same or similar characteristics, for example, same gender, similar age, or similar occupation. The on-demand service system 100 then may analyze and obtain a user's statistical vehicle preference associated with their demographic profile. For example, if the historical service requests sent by the requestor are mostly for vehicles of a certain vehicle brand (e.g., BMW), the processing engine 112 may recommend one or more new launched vehicles of the certain vehicle brand to the requestor. As another example, the processing engine 112 may analyze service requests sent by the peer group and determine which vehicle models are preferred by the peer group, and then, the processing engine 112 may push some vehicles with a similar vehicle model to the requestor.

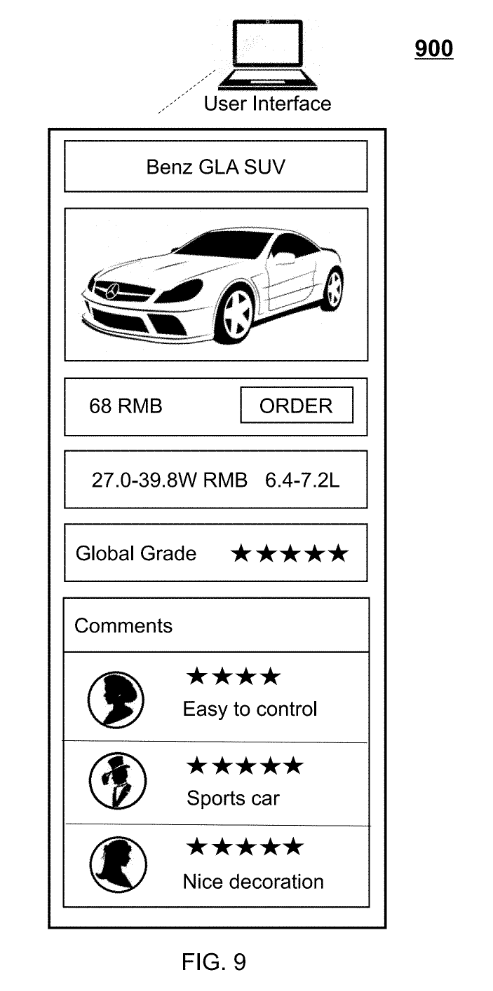

FIG. 9 is a schematic diagram illustrating an exemplary user interface 900 for requestor usage according to some embodiments of the present disclosure. The user interface 900 for requestor usage may be shown on the requestor terminal 130 when the requestor wishes to view information relating to a specific vehicle or when the requestor wishes to grade or make comments on a specific vehicle. For example, when the processing engine 112 pushes a specific vehicle to the requestor via the recommendation illustrated in FIG. 8-A or FIG. 8-B, the requestor may click to the user interface 900 to view the information relating to the specific vehicle. As another example, the requestor may make comments on the specific vehicle on the user interface 900 after the processing engine 112 completes a service request (i.e., the requestor completes a payment for the service request).

As illustrated in FIG. 9, the vehicle brand, the vehicle model, a picture of the vehicle, a basic fee, an “ORDER” button, one or more key parameters of the vehicle, a global grade, and comments may be shown. The one or more key parameters may include a price range, a displacement, or the like, or any combination thereof. The one or more key parameters may be default settings of the on-demand service system 100. The requestor may send a service request for an authority to drive the vehicle by pressing the “ORDER” button.

As illustrated, comments relating to test drive experience of the vehicle may be shown. The comment may include a grade, a short comment, a detailed comment, or the like, or a combination thereof. The grade may be expressed by starts, thump-up icons, heart icons, or the like, or a combination thereof. For example, “five stars” refers to a favorable comment, while “one star” refers to an unsatisfactory comment. The short comment may be expressed by a phrase, a short sentence, an emoticon, or the like, or a combination thereof. For example, a requestor may give a short comment “easy to control” regarding the vehicle. The detailed comment may be expressed by a paragraph, a long sentence, a picture, or the like, or a combination thereof.

In some embodiments, the processing engine 112 may control which comments may appear on the user interface 900. For example, the processing engine 112 may control the user interface 900 to display the comments by time (e.g., comments given during the last week). As another example, the processing engine 112 may filter the comments according to the text lengths of the comments and control the user interface 900 to display the comments whose text lengths are larger than a threshold (e.g., 50 words). As a further example, the processing engine 112 may control the user interface 900 to display the comments according to click rate, for example, from high to low.

The global grade may be determined based on the grades in the comments. For example, the processing engine 112 may determine the global grade of the vehicle by averaging all the grades in the comments given by the requestors. The global grade may be expressed by a numerical value or combinations of one or more icons (e.g., stars, thumb-up icons).

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the user interface 900 may show the number of requestors that sent service request for the vehicle within a period of time in the past. As another example, the user interface 900 may provide a link (not shown) to an external resource (e.g., a website, a database, a cloud storage). The requestor may obtain information relating to the vehicle (e.g., news, blogs) from the external resource via the link.

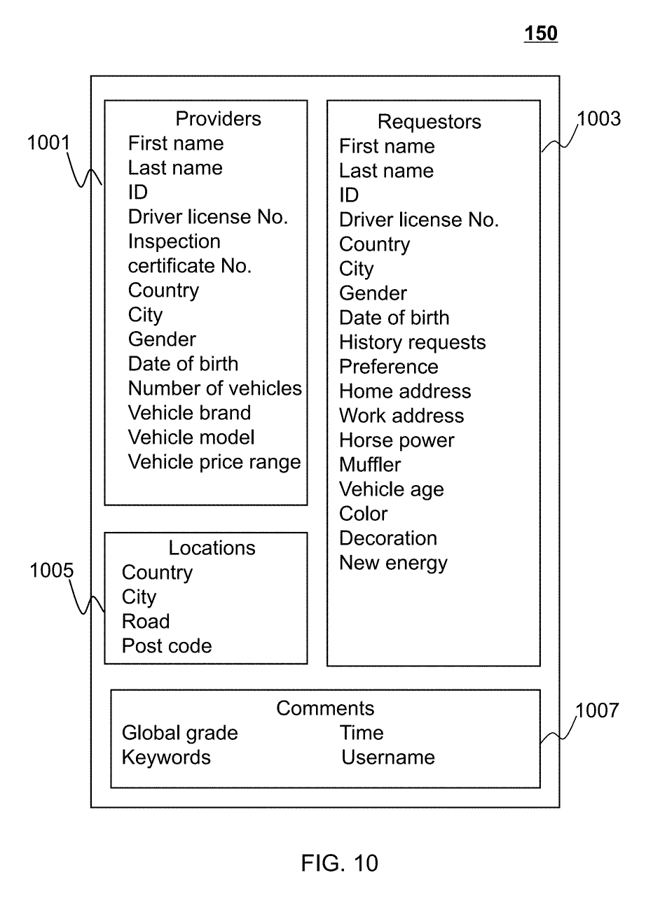

FIG. 10 is a block diagram illustrating an exemplary database according to some embodiments of the present disclosure. The database 150 may include a provider information section 1001, a requestor information section 1003, a location information section 1005, and a comment information section 1007.

The provider information section 1001 may include information relating to the providers, for example, personal information and vehicle information. The personal information may include a first name, a last name, an ID, a driver license number, a country, a city, a gender, a date of birth, or the like, or any combination thereof. The vehicle information may include the number of vehicles, inspection certificate numbers of the vehicles, a vehicle brand, a vehicle model, a price range, or the like, or any combination thereof. The information relating to the providers may be expressed in a format of text, numerical value, picture, audio, or video. For example, the first name or the last name may be expressed in a format of text. The driver license number and the date of birth may be expressed in format of numerical values.

The requestor information section 1003 may include information relating to the requestors, for example, personal information, default location data, or vehicle preference information. The personal information of the requestor may include a first name, a last name, an ID, a driver license number, a country, a city, a gender, a date of birth, or the like, or any combination thereof. The default location data may include a home address or a work address. The vehicle preference information may include a horse power, a muffler, a vehicle age, a color, a decoration, or the like, or any combination thereof. The requestor information section 1003 may further include information relating to historical service requests sent by the requestors. Take a specific requestor as an example, the information relating to historical service requests may include the number of service request sent by the requestor, a regular start location, a request frequency (e.g., once a month, five times a week), etc.

In some embodiments, the information relating to the providers or the requestors may be expressed as a plurality of tables. In some embodiments, a table (e.g., Table 2) may correspond to a user (e.g., a provider, a requestor). In some embodiments, a table (e.g., Table 3) may correspond to a plurality of users.

TABLE 2
a schematic table corresponding to a user (requestor A)

| | |
|---|---|
| First name | Alice |
| Last name | Baker |
| Gender | Female |
| Age | 30 |
| Country | USA |
| City | New York |

TABLE 3
a schematic table corresponding to a plurality of users

| User | First name | Last name | Gender | Age | Country | City |
|---|---|---|---|---|---|---|
| A | Alice | Baker | Female | 30 | USA | New York |
| B | Catherine | Donovan | Female | 25 | Canada | Vancouver |
| C | Eric | Firth | Male | 27 | USA | Washington |
| | | | | | | D.C. |
| D | George | Harker | Male | 40 | USA | Chicago |
| E | Ivan | Jackson | Male | 52 | USA | New York |

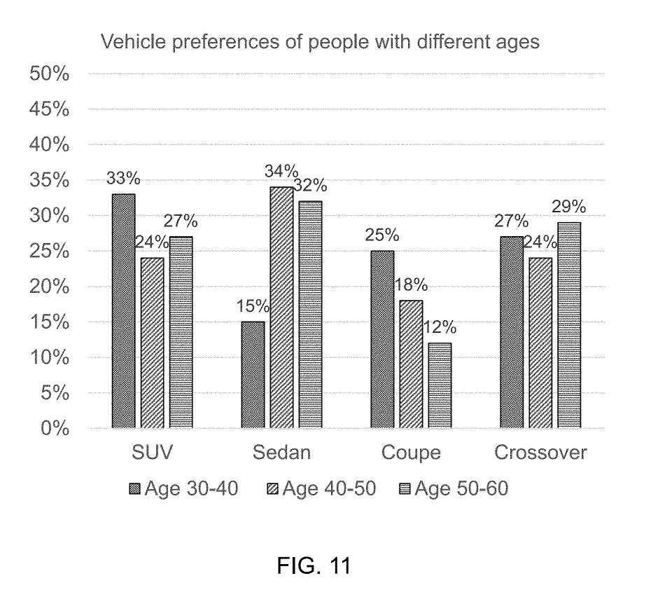

In some embodiments, the information relating to the providers or the requestors may be classified according to different keywords (e.g., age, city). In some embodiments, the provider information section 1001 or the requestor information section 1003 may further include a statistical result based on the information relating to the providers or the requestors. For example, the statistical result may include vehicle preferences of people with different ages. As another example, the statistical result may include vehicle preferences of people with different genders. The statistical result may be expressed as a table including statistical data, a textual description, a statistical graph (e.g., a statistical graph shown in FIG. 11), or the like, or a combination thereof. The statistical graph may include a histogram, a line chart, a pie chart, a bubble diagram, or the like, or a combination thereof.

In some embodiments, the provider information section 1001 and the requestor information section 1003 may further include information relating to the provider terminal 140 and the requestor terminal 130 respectively (not shown). The information relating to the provider terminal 140 or the requestor terminal 130 may include the registration time of the user (e.g., the provider, the requestor), the last login time of the user, settings of the provider terminal 140 or the requestor terminal 130 (e.g., whether the user wishes to receive notifications on the provider terminal 140 or the requestor terminal 130), or the like, or a combination thereof.

The location information section 1005 may include location information relating to the service requests, for example, start location, destination, or route. The location information section 1005 may include country, city, road, or post code. The location information section 1005 may be expressed in a format of text, numerical value, map coordinate, or picture.

The comment information section 1007 may include global grade, keywords, time, or usernames. The processing engine 112 may organize the comment information in a form of table. For illustration purposes, Table 4 below illustrates the comment information relating to a specific vehicle as an example.

TABLE 4
a schematic table illustrating comment information relating
to a vehicle

| Username | Global grade | Keyword | Time |
|---|---|---|---|
| A | 5 | Easy to control | 2016.10.31 |
| B | 5 | Automatic catch | 2016.10.28 |
| C | 3 | Good shape | 2016.10.30 |
| D | 4 | Small displacement | 2016.10.30 |
| E | 2 | Beautiful color | 2016.10.29 |

FIG. 11 is a schematic diagram illustrating an exemplary statistical graph according to some embodiments of the present disclosure. For illustration purposes, FIG. 11 describes a histogram as an example, it should be noted that a statistical graph expressed by other forms (e.g., a line chart, a pie chart, a bubble diagram) is applicable in this disclosure.

Merely by way of an example, a histogram illustrating vehicle preferences of people with different ages is provided. As illustrated, the horizontal coordinate refers to vehicle model, the vertical coordinate refers to the percentage of the vehicle model which is requested by a requestor. The vehicle model includes SUV, Sedan, Coupe, and Crossover. The requests relating to the vehicle models may be classified according to ages of the requestors. The ages of the requestors may be classified as age intervals including 30-40, 40-50, and 50-60.

As illustrated in the statistical graph, for requestors within the age interval 30-40, when selecting a vehicle to experience, 33% prefer SUV, 27% prefer crossover, 25% prefer coupe, and 15% prefer sedan. For requestors within the age interval 40-50, 34% prefer sedan, 24% prefer SUV, 24% prefer crossover, and 18% prefer coupe. For requestors within the age interval 50-60, 32% prefer sedan, 29% prefer crossover, 27% prefer SUV, and only 12% prefer coupe. It may be seen that SUV and crossover have similar attractions for requestors within different age intervals. Sedan is preferred by older requestors (requestors within age intervals 40-50 and 50-60), while coupe attracts younger requestors (requestors within age interval 30-40).

For illustration purposes, FIG. 11 describes a statistical graph relating to vehicle preferences of people with different ages and not intends to limit the scope of the present disclosure. For example, a statistical graph relating to vehicle preferences of people with different genders, cities, or household incomes may be provided.

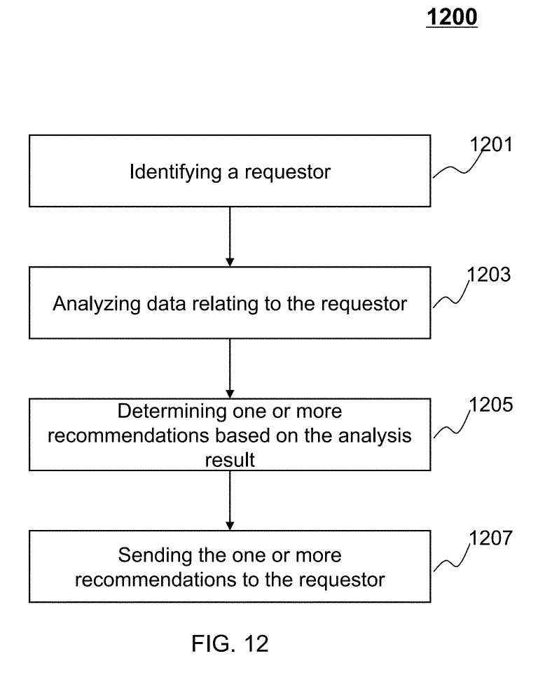

FIG. 12 is a flowchart illustrating an exemplary process/method 1200 for sending one or more recommendations to a requestor according to some embodiments of the present disclosure. The process/method 1200 may be executed by the on-demand service system 100. For example, the process and/or method 1200 may be implemented as a set of instructions (e.g., an application) stored in the storage ROM 230 or RAM 240. The CPU 210 may execute the set of instructions and may accordingly be directed to perform the process and/or method 1200.

In step 1201, the processing engine 112 may identify a requestor. The processing engine 112 may identify the requestor by identifying a username, a real name or an ID. The processing engine 112 may select the requestor randomly from all the requestors that registered with the system 100. The processing engine 112 may select the requestor according to a predetermined condition. For example, the processing engine 112 may select a requestor who is active within a predefined time interval (e.g., the past month). As used herein, “active” refers to that the requestor sent a plurality of service requests within the predefined time interval, the number of the plurality of service requests is larger than a threshold (e.g., 10).

In step 1203, the processing engine 112 may analyze data relating to the requestor. The data relating to the requestor may include personal information, vehicle preference, historical service requests sent by the requestor, comments relating to one or more vehicles given by the requestor, or the like, or a combination thereof. For example, the data may be from the hierarchical database as above-introduced in the present disclosure, and the database may be stored as the database 150. The processing engine 112 may obtain the data from the database 150 shown in FIG. 10. The processing engine 112 may analyze the data relating to the requestor and determine an analysis result. The analysis result may be associated with an individualized vehicle preference of the requestor.

In some embodiments, the processing engine 112 may analyze the vehicle preference inputted by the requestor when the requestor registers with the system 100. In some embodiments, the processing engine 112 may analyze the historical service requests sent by the requestor. The processing engine 112 may determine which vehicle (e.g., Benz GLA 220) or which kind of vehicle (e.g., SUV) is frequently test driven by the requestor. In some embodiments, the processing engine 112 may analyze the historical comments given by the requestor. The processing engine 112 may determine which vehicle or which kind of vehicle is given a favorable comment by the requestor. For example, the processing engine 112 may determine a certain vehicle which is given a grade larger than a grade threshold (e.g., 4 starts).

In step 1205, the processing engine 112 may determine one or more recommendations based on the analysis result. The one or more recommendations may be associated with one or more vehicles associated with the individualized vehicle preference of the requestor. For example, if the analysis result indicates that the requestor prefers a certain kind of vehicle (e.g., SUV) with a certain price range (e.g., 25 W-35 W), the processing engine 112 may generate a recommendation relating to SUV vehicles of various vehicle brands with the certain price range.

In step 1207, the processing engine 112 may send the one or more recommendations to the requestor. The processing engine 112 may send the recommendations at default time points set by the system 100 or at a defined time point by the requestor. For example, the default time points may be a time point when the requestor logins the system 100 or a time point when the system 100 completes a service request. As another example, the requestor may define a specific time point (e.g., 18:00 pm) or a time interval (19:00-22:00 pm) when the requestor wishes to receive notifications or recommendations. In some embodiments, the processing engine 112 may send the one or more recommendations in different forms (e.g., text, picture, audio, video).

In some embodiments, as described in connection with FIG. 8-A or FIG. 8-B, the processing engine 112 may analyze data relating to a peer group, determine one or more recommendations based on the data relating the peer group, and send the one or more recommendations to the requestor.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system, comprising:
a bus;
one or more storage media electronically connected to the bus, comprising a set of instructions for determining a target provider for a service request; and
logic circuits electronically connected to the one or more storage media via the bus, wherein during operation, the logic circuits load the set of instructions and;
obtain electronic signals from the bus, the electronic signals including a service request from a requestor for an authority to drive a vehicle by the requestor;
determine a target vehicle corresponding to a target provider based on the service request; and
direct the target provider to send the target vehicle to the requestor.

2. The system of claim 1, wherein the service request is a test drive request to test drive the target vehicle.

3. The system of claim 1, wherein to obtain a service request from a requestor, the logic circuits further:
obtain the service request from a requestor terminal associated with the requestor; and
wherein to direct the provider to send the target vehicle to the requestor, the logic circuits further:
direct the target provider to send the target vehicle to the start location via a provider terminal associated with the target provider.

4. (canceled)

5. The system of claim 1, wherein the service request includes at least one of a start location to drive the target vehicle or an individualized definition of the vehicle.

6. The system of claim 5, wherein the service request further includes an open destination.

7. (canceled)

8. (canceled)

9. The system of claim 5, wherein the individualized definition of the vehicle includes at least one preference parameter, which includes at least one of a vehicle brand, a vehicle model, an overall dimension, an inner dimension, a driving type, a displacement, a gear box, a clutch, a fuel tank, a brake system, a steering system, a self-driving system, an air conditioning, an audio system, a lamp, a seat, a maximum speed, a horse power, a vehicle age, a color, a painting, a decoration, a muffler, or new energy.

10. The system of claim 5, wherein to determine the target vehicle, the logic circuits further:
send the service request to a plurality of candidate providers within a predetermined distance from the start location, each of the plurality of candidate providers being associated with a candidate vehicle;
receive an acceptance of the service request from at least one candidate provider of the plurality of candidate providers; and
select one candidate provider from the at least one of candidate providers as the target provider.

11. The system of claim 10, wherein to send the service request to a plurality of candidate providers, the logic circuits further:
obtain status information of each of a plurality of vehicles, each of the plurality of vehicles being associated with a provider of the plurality of providers;
determine a plurality of available vehicles based on the status information, wherein each of the plurality of available vehicles is a vehicle that is available to provide the requestor the authority to drive the available vehicle;
from the plurality of available vehicles, select the plurality of candidate vehicles that matches the service request; and
send the service request to the plurality of candidate providers associated with the plurality of candidate vehicles within the predetermined distance from the start location.

12. (canceled)

13. The system of claim 11, wherein to select the plurality of candidate vehicles, the logic circuits further:
determine vehicle information of the available vehicles; and
match the individualized definition of the vehicle with the vehicle information.

14. The system of claim 10, wherein the plurality of candidate providers includes at least one of a dealer, a private seller, or a private owner of the candidate vehicle.

15. The system of claim 1, wherein the logic circuits further:
collect data relating to the requestor, the data including historical service requests by the requestor;
determine a recommendation based on the data; and
notify the recommendation to the requestor.

16. The system of claim 1, wherein to obtain the service request from the requestor for the authority to drive the vehicle by the requestor, the logic circuits further:
collect personal information from the requestor, and
determine eligibility information of the requestor; and
wherein to determine a target vehicle corresponding to a target provider based on the service request, the one or more processors are directed to:
collect personal information from the candidate provider, and
determine eligibility information of the candidate provider.

17. (canceled)

18. A method configured to operate an online on-demand transportation service on at least one electronic device having logic circuits, at least one storage medium, and a communication platform connected to a network, comprising:
obtaining, by the logic circuits, a service request from a requestor for an authority to drive a vehicle by the requestor;
determining, by the logic circuits, a target vehicle corresponding to a target provider based on the service request; and
directing, by the logic circuits, the target provider to send the target vehicle to the requestor.

19. The method of claim 18, wherein the service request is a test drive request to test drive the target vehicle.

20. The method of claim 18, wherein the obtaining of the service request includes:
obtaining, by the logic circuits, the service request from a requestor terminal associated with the requestor; and
wherein the directing of the provider to send the target vehicle to the requestor includes:
directing, by the logic circuits, the target provider to send the target vehicle to the start location via a provider terminal associated with the target provider.

21. (canceled)

22. The method of claim 18, wherein the service request includes at least one of a start location to drive the target vehicle or an individualized definition of the vehicle.

23. The method of claim 22, wherein the service request further includes an open destination.

24. (canceled)

25. (canceled)

26. The method of claim 22, wherein the individualized definition of the vehicle includes at least one preference parameter, which includes at least one of a vehicle brand, a vehicle model, an overall dimension, an inner dimension, a driving type, a displacement, a gear box, a clutch, a fuel tank, a brake system, a steering system, a self-driving system, an air conditioning, an audio system, a lamp, a seat, a maximum speed, a horse power, a vehicle age, a color, a painting, a decoration, a muffler, or new energy.

27. The method of claim 22, wherein the determining of the target vehicle includes:
sending, by the logic circuits, the service request to a plurality of candidate providers within a predetermined distance from the start location, each of the plurality of candidate providers being associated with a candidate vehicle;
receiving, by the logic circuits, an acceptance of the service request from at least one candidate provider of the plurality of candidate providers; and
selecting, by the logic circuits, one candidate provider from the at least one of candidate providers as the target provider.

28. The method of claim 27, wherein the sending of the service request to a plurality of candidate providers includes:
obtaining, by the logic circuits, status information of each of a plurality of vehicles, each of the plurality of vehicles being associated with a provider of the plurality of providers;
determining, by the logic circuits, a plurality of available vehicles based on the status information, wherein each of the plurality of available vehicles is a vehicle that is available to provide the requestor the authority to drive the available vehicle;
from the plurality of available vehicles, selecting, by the logic circuits, the plurality of candidate vehicles that matches the service request; and
sending, by the logic circuits, the service request to the plurality of candidate providers associated with the plurality of candidate vehicles within the predetermined distance from the start location.

29. (canceled)

30. (canceled)

31. (canceled)

32. (canceled)

33. (canceled)

34. (canceled)
